(19) United States
(12) Patent Application Publication
(10) Pub. No.: US 2010/0262280 A1
(43) Pub. Date: Oct. 14, 2010

(54) Display-Based Vending Apparatus and Method

(76) Inventors: Michael A. Miller, Elmhurst, IL (US); Paul Schindelar, Baltimore, MD (US); Nathaniel J. Hedtke, Cary, IL (US); Frank Guzzone, Lorton, VA (US); Malcolm McAlpine, Flanders, NJ (US); Brian Sobecks, Glenview, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 12/759,189

(22) Filed: Apr. 13, 2010

Related U.S. Application Data
(60) Provisional application No. 61/168,784, filed on Apr. 13, 2009.

(51) Int. Cl. G06F 17/00; H04N 5/64; B65D 83/00

(52) U.S. Cl. 700/234; 348/836; 221/282; 221/24; 348/E07.091

(57) ABSTRACT

A vending-machine has one or more displays that inform the customer regarding available vendable selections and that facilitate the purchase of a selected item. By one approach this display can comprise a touchscreen display. Such an approach can support a highly intuitive interaction between the purchasing context and the customer. A display of dynamic content serves to attract a potential customer, provide the customer with a wealth of information regarding available selections, offer the customer a variety of ways to consider and assess available vendable items, support the building of a customer relationship between the customer and one or more marketing brands, and effect the successful conclusion of a vending transaction.

### RELATED APPLICATION(S)

This application claims the benefit of U.S. Provisional application No. 61/168,784, filed Apr. 13, 2009 and entitled DISPLAY-BASED VENDING APPARATUS AND METHOD, which is incorporated by reference in its entirety herein.

### TECHNICAL FIELD

This invention relates generally to vending machines.

### BACKGROUND

Vending machines are known in the art. As used herein, references to a “vending machine” (or “vending apparatus” or “vending platform”) will be understood to refer to an apparatus that serves, in the absence of a human custodian, attendant, or operator to provide a customer with some product or service in exchange for some consideration. Millions of vending machines, for example, serve to exchange a customer's proffered coins or currency for food items or drinks. Many other items are similarly offered via this approach.

By one typical approach, the customer can view the vending machine's product storage area (often through a protective transparent window). This permits the customer to readily understand which products are presently available for vending. In such a case individual item prices are often displayed via a small corresponding sign with each category of item. Such a machine will sometimes respond to depositing of the customer's money by causing the selected item to move in some manner to thereby be released from a holding mechanism and drop down into a receiving area. The customer then reaches into the receiving area to retrieve their selection.

By another typical approach, the customer cannot directly view the vending machine's storage area but is apprised of the available items via displayed samples or signage. Vending machines of this type often employ the bulk of their exterior to post static signage to advise the customer of the machine's contents and also to hopefully tempt the customer to in fact make a corresponding purchase. Such a machine will also often include a small indicator (for example, an illuminated light source such as a small incandescent bulb or a light emitting diode (LED)) to indicate which selections are presently sold out or otherwise unavailable.

For the most part, promotional possibilities remain quite limited for such vending machines and tends to focus on the provision of static signage and/or a heavy reliance upon display of the machine's storage area. This may be due to a belief that the overall transaction appears quite simple (i.e., advise the customer of a small selection of items, perceive their selection, and successfully exchange that selection for a monetary consideration) and has not fundamentally changed since virtually the earliest of vending machines.

### BRIEF DESCRIPTION OF THE DRAWINGS

The above needs are at least partially met through provision of the display-based vending apparatus and method described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention;

FIG. 3 comprises a front-elevational schematic view as configured in accordance with various embodiments of the invention;

FIG. 4 comprises a flow diagram as configured in accordance with various embodiments of the invention;

FIG. 5 comprises a front-elevational schematic view as configured in accordance with various embodiments of the invention;

FIG. 6 comprises a front-elevational schematic view as configured in accordance with various embodiments of the invention;

FIG. 7 comprises a front-elevational schematic view as configured in accordance with various embodiments of the invention;

FIG. 8 comprises a front-elevational schematic view as configured in accordance with various embodiments of the invention;

FIG. 9 comprises a flow diagram as configured in accordance with various embodiments of the invention;

FIG. 10 comprises a front-elevational schematic view as configured in accordance with various embodiments of the invention;

FIG. 11 comprises a front-elevational schematic view as configured in accordance with various embodiments of the invention;

FIG. 12 comprises a flow diagram as configured in accordance with various embodiments of the invention;

FIG. 13 comprises a front-elevational schematic view as configured in accordance with various embodiments of the invention;

FIG. 14 comprises a flow diagram as configured in accordance with various embodiments of the invention;

FIG. 15 comprises a front-elevational schematic view as configured in accordance with various embodiments of the invention;

FIG. 16 comprises a front-elevational schematic view as configured in accordance with various embodiments of the invention; and

FIG. 17 comprises a front-elevational schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a vending-machine has one or more displays that inform the customer regarding available vendable selections and that facilitate the purchase of a selected item. By one approach this display can comprise a touch screen display. Such an approach can support a highly intuitive interaction regarding the purchasing context for the customer. These teachings readily support the display of dynamic content that can serve to attract a potential customer, provide the customer with a wealth of information regarding available selections, offer the customer a variety of ways to consider and assess available vendable items, support the building of a customer relationship between the customer and one or more marketing brands, and effect the successful conclusion of a vending transaction. Those skilled in the art will appreciate that these teachings are highly flexible and can be leveraged in a wide variety of application settings. It will further be appreciated that these teachings are highly scalable and can be readily employed with a wide variety of vendable items and services.

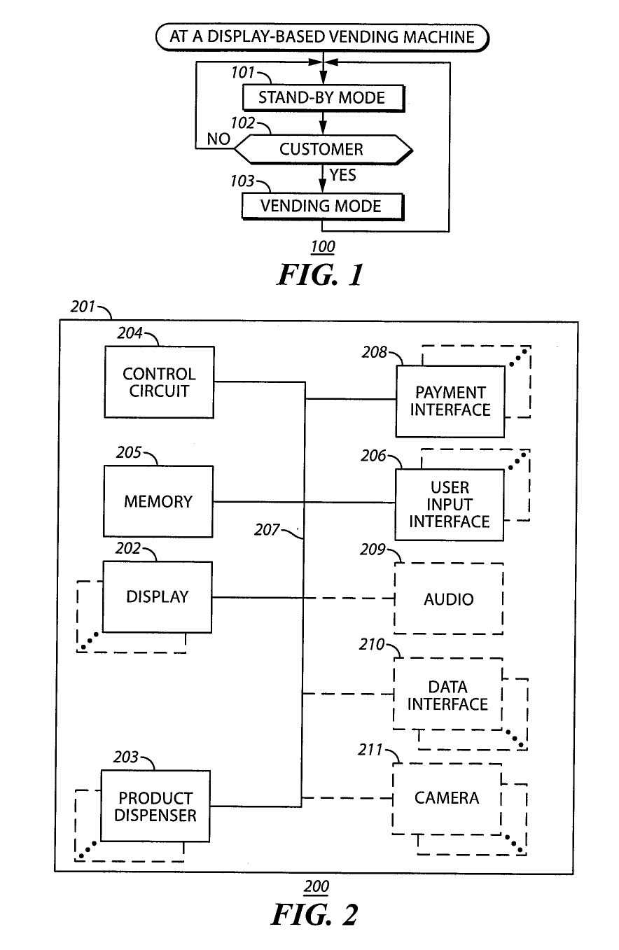

These and other benefits may become clearer upon making a thorough review and study of the following detailed description. Referring now to the drawings, and in particular to FIG. 1, an illustrative process 100 that is compatible with many of these teachings will now be presented. This process 100 can be carried out by a display-based vending machine. Those skilled in the art will recognize that any of a wide variety of architectural and component choices will serve to embody such a machine. For the sake of illustration and not by way of limitation, and referring momentarily to FIG. 2, such a display-based vending machine 200 can comprise a housing 201 having one or more displays 202 (such as, for example, flat-screen video displays as are known in the art) that are viewable by a customer and a product dispenser (or dispensers) 203 to store, retrieve, and physically deliver vendable items/services to a corresponding customer. Such displays 202 and product dispensers 203 are well known in the art. For the sake of brevity and for the purpose of clarity, further elaboration in this regard will not be provided here.

This display-based vending machine 200 can further comprise a control circuit 204 that operably couples to the display 202 and the product dispenser 203 in order to interact with and control such components. Those skilled in the art will recognize and appreciate that such a control circuit 204 can comprise a fixed-purpose hard-wired platform or can comprise a partially or wholly programmable platform. All of these architectural options are well known and understood in the art and require no further description here. This machine 200 can further comprise a memory 205 that operably couples to at least the control circuit 204 and the display 202. This memory 205 can store, for example, instructions to be executed by the control circuit 204 as correspond to the teachings presented herein. This memory 205 can also store, for example, displayable content to be selectively presented via the display 202. (It will be understood that the memory component shown can comprise a plurality of memory elements or can be comprised of a single memory element (as is suggested by the illustration).)

Such an apparatus 200 will also typically comprise one or more user-input interfaces 206 that also operably couple to the control circuit 204. This interface 206 serves to permit a customer to, for example, select a particular vendable item. By one approach, this user-input interface 206 can comprise a related or integral part of the display 202. For example, the display 202 can comprise a touch screen display as is known in the art. So configured, the customer can provide input to the control circuit 204 by touching particular portions of the screen comprising the display 202. One or more of these user-input interfaces 206 may also accommodate other interface paradigms. Examples in these regards include, but are not limited to, cursor control interfaces (such as a mouse, arrow keys, trackball, joystick, or the like), alphanumeric-entry keypads, dedicated (or soft) buttons, switches, or the like, voice-recognition interfaces, gesture-recognition interfaces, gaze-tracking interfaces, and so forth. Such user-input interfaces are generally known in the art and, for the sake of brevity, will not be described further here.

These above-described components can communicate as appropriate amongst themselves via any appropriate data interface. As illustrated, for example, a serial-data bus 207 interconnects these components. This permits, for example, the control circuit 204 to communicate with any of these components as necessary or appropriate and for displayable content from the memory 205 to be readily provided to the display 202. Those skilled in the art will recognize that other possibilities exist in these regards. For example, a star-based configuration could serve to directly link the control circuit 204 to one or more of these components. As yet another example, a daisy chain-based configuration could serve to connect some or all of these components in a loop.

Depending upon the needs of a given application setting, such a machine 200 can readily accommodate other components as well. For example, such a machine 200 will typically have one or more payment interfaces 208. Such payment interfaces 208 are known in the art and can serve to accept payment in the form of coins, currency, credit or debit card transactions, coupons or tokens, biometrics (as when a customer's fingerprint serves as their virtual credit or debit card), and wireless transactions (as when the customer presents a wireless smartcard, radio frequency identifier (RFID)-based card, module, or the like), to note but a few examples in these regards.

Such a machine 200 can also comprise an audio component 209. This audio component can serve to store and selectively render audible any of a variety of useful sounds. These sounds can accompany and be synchronized with displayed video content or can comprise stand-alone audible content. The audible content itself can comprise any sounds that may be useful or necessary to meet the needs or opportunities as tend to characterize a given application setting. These sounds can include, but are not limited to, human speech, music, sound effects (for example, fanciful sounds or sounds that are appropriate and expected in the context of interacting with a vending machine), or tones or signals of various kinds that serve as alerts, indicators, acknowledgements, or the like.

This machine 200 can also comprise, as desired, one or more data interfaces 210 to thereby provide access to one or more resources external to the machine 200. Numerous examples are known in the art. A non-exhaustive listing would include Universal Serial Bus (USB)-based interfaces, RS232-based interfaces, Firewire-based interfaces, Ethernet-based interfaces, any of a variety of so-called wifi-based wireless interfaces, Bluetooth-based wireless interfaces, cellular telephony-based wireless interfaces, standard telephone landline-based interfaces, cable modem-based interfaces, and digital subscriber line (DSL)-based interfaces. Such interfaces can be selectively employed to communicatively couple the machine 200 to another such machine, to a local area network, or to any of a variety of wide area networks or extranets (such as, but not limited to, the Internet).

Such a machine 200 can also comprise, if desired, one or more cameras 211. This can comprise a still camera or a video camera as desired and may have a set field of view or a selectively variable orientation or zoom capability as desired. Such a camera can be configured, for example, to view (and capture images of) some portion of or all of the customer (or customers) when standing before the machine 200.

Those skilled in the art will recognize that the latter components can again operably couple to the control circuit 204 or other components of the display-based vending machine 200 via the depicted serial bus 207 or any other connectivity mechanism of choice.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

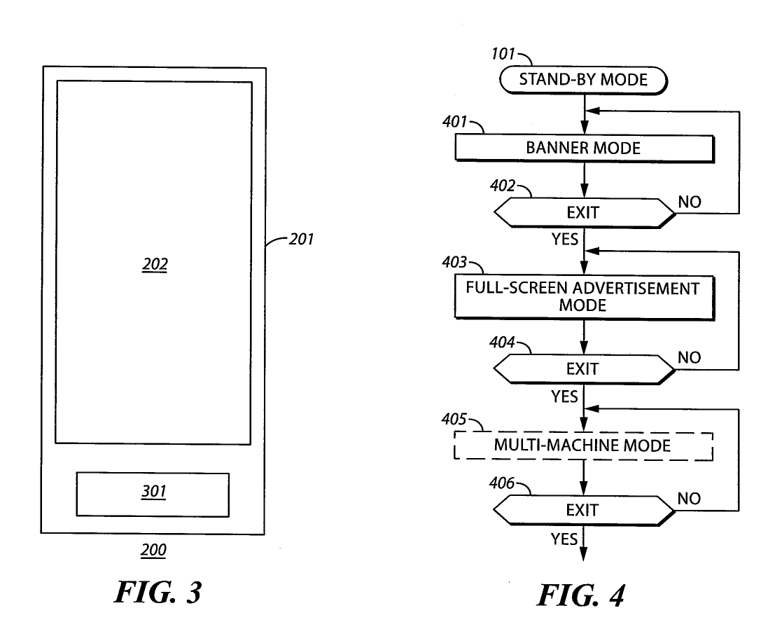

With momentary reference to FIG. 3, this generalized schematic representation of a display-based vending machine 200 illustrates that the display 202 can be mounted on the front side of the machine 200 and can comprise a large portion of that side. As shown, for example, this display 202 can equal greater than thirty percent of the available front surface of the machine 200. As another example, this display 202 can equal greater than forty percent of the available front surface of the machine 200. As yet another example, this display 202 can equal greater than fifty percent of the available front surface of the machine 200. And as yet another example in these regards, this display 202 can equal greater than seventy percent of the available front surface of the machine 200.

In this example, the machine's front side also includes a vended-product delivery area 301. This can comprise an inset compartment into which vended items are placed. The customer (not shown) can then reach into this compartment to grasp and remove their vended item. For the sake of simplicity and illustrative ease, the remainder of this description will presume such a form factor and design for the display-based vending machine 200. Those skilled in the art will recognize that numerous other possibilities exist in these regards, however, and that these teachings are equally as applicable for use with a wide variety of other designs.

Returning again to FIG. 1, it can be seen that this process 100 generally provides for a stand-by mode 101 and a vending mode 103. Generally speaking, the machine 200 operates using the stand-by mode 101 unless and until the process 100 detects at step 102 a customer. Such detection can comprise, for example, detecting an input of the customer as delivered via the aforementioned user-input interface 206. Such detection may also comprise, for example, detecting the presence of the customer via processing of captured images from the aforementioned camera 211 by the machine's control circuit 204. Other approaches can serve in these regards as well, including the use of Bluetooth-based detection, proximity detectors of various kinds, and so forth.

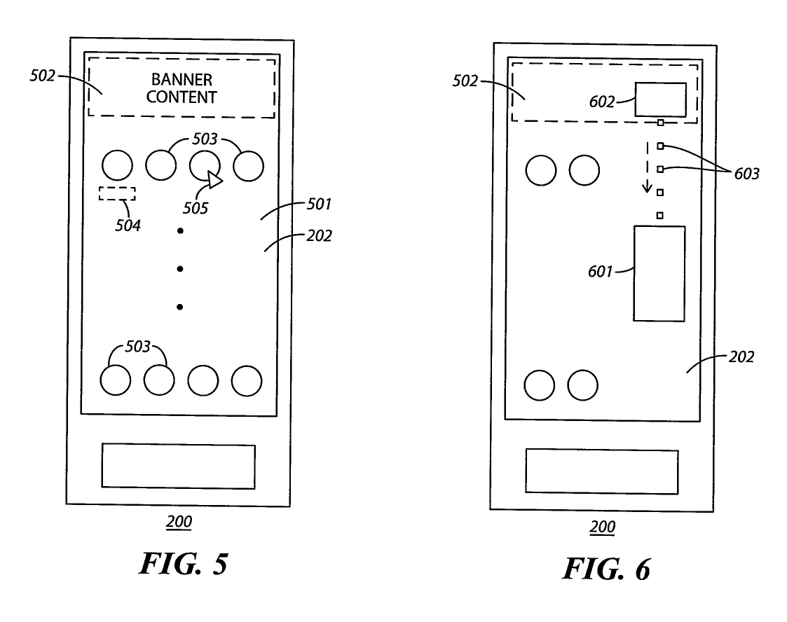

Referring now to FIG. 4, this stand-by mode 101 will be described. This stand-by mode 101 generally presumes the absence of an immediately-interested customer and therefore generally serves to attract such a candidate. This can comprise using the step 401 of providing a so-called banner mode of operation. With momentary reference to FIG. 5, this can comprise using only a portion of the machine's display 202 to present banner content 502.

In this illustrative example this banner content 502 is situated above a portion of the display 501 that serves to present available vendable items 503 (represented here schematically by circles though it will be understood that these displayed representations can comprise any desired form and shape including a virtual graphic representation of the item itself, such as a bag of peanuts, a small package of cookies, a 12 ounce can of carbonated beverage, or the like). If desired, a corresponding legend 504 can accompany some or all of the individually displayed vendable items 503. This legend 504 can present, for example, price information as pertains to the corresponding vendable item 503. When the user interface comprises, at least in part, a cursor control mechanism, this display area 501 can also include the corresponding cursor 505. So configured, it will be appreciated that such a display area 501 can appear similar to many traditional vending machines that feature a live view of the machine's vendable item storage and display area.

In any event, the aforementioned banner content 502 can comprise any of a variety of forms. By one approach this banner content 502 can simply comprise a static presentation of a still image. By another approach this banner content 502 can comprise a slide show of sequentially-offered still images. By yet another approach this banner content 502 can comprise video material offering moving images. Those skilled in the art will appreciate that various combinations of these various presentation approaches can also be employed in sequence or can even be used simultaneously in different portions of the banner display area.

The substance of this banner content 502 can of course vary with the needs and/or opportunities as tend to characterize a given application setting. As one example, this banner content 502 can serve to use color and motion to attract the attention of passers by. As another example, this banner content 502 can serve to provide the viewer with images directly pertaining to one or more of the vendable items available at this machine 200 (such as animated images of the items as wrapped or presented as a serving suggestion). Other possibilities exist as well in these regards. For example, this banner content can present customer relationship building material such as, but not limited to, recipes or other related use cases, contact information, charitable sponsorships and opportunities, sponsored events and promotions, other non-machine purchasing opportunities, and so forth. This banner content 502 can also comprise other kinds of information that is not particularly related, in and of itself, to the vendable items or a particular customer relationship. Examples in this regard might include breaking news feeds, weather reports and forecasts, advertisements for products and services of third parties, entertainment content, and so forth.

As described above, this banner content 502 resides within a segregated area of the display 202 to thereby separate that banner content 502 from a display 501 of the vendable item selections. These teachings will accommodate, however, at least an occasional (or constant, if desired) intermingling of the banner content 502 with the primary vendable items display 501. As one illustrative example in these regards, and referring now momentarily to FIG. 6, a particular displayed vendable item 601 can be emphasized (for example, by enlarging the size of the displayed item) while a source of contents 602 for that particular vendable item 601 appears in the banner area and pours its contents 603 out into the displayed container for the vendable item 601.

For example, the emphasized vendable item 601 could comprise a bag of peanuts and the source of contents 602 could comprise a can of peanuts. Using animated elements, the display of the can of peanuts can appear to open and tip over to cause a stream of peanuts to fall down into the waiting bag of peanuts to thereby fill the bag. Such a presentation could of course be accompanied by appropriate corresponding sounds, such as the sound of an opening can and the sound of peanuts falling into a plastic bag. Such a display could sequentially follow, if desired, for a number of the different selectable items to thereby drawn the attention and possible consuming interest of passers by and onlookers.

In the examples shown, the banner content 502 appears at the top of the display 202. This banner content 502, however, can be provided essentially anywhere on the display. These teachings will also readily accommodate using two or more discrete areas of banner content, including areas having differing sizes, differing shapes, and so forth. It would also be possible for the banner area itself to move in a discontinuous or continuous basis.

Referring still to FIG. 4, this banner mode 401 can persist until the process determines to exit 402 this mode. This exit decision 402 can be based upon whatever decision-making criterion may be relevant to the needs of a given application setting. By one approach, for example, this decision can be time based. Using this approach, use of the banner mode 401 may continue only for a predetermined amount of time, such as thirty seconds, two minutes, or such other duration as may be suitable. By another approach, and as another example, this decision can be content based. Using this approach, use of the banner mode 401 may continue until the available banner content has all been used.

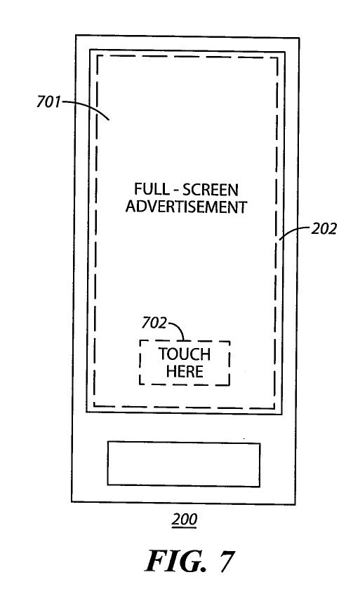

Upon exiting the banner mode 401, and if desired, this stand-by mode 101 can accommodate a full-screen advertisement mode 403. Referring momentarily to FIG. 7, this can essentially comprise using all, or substantially all, of the full display 202. This notion of using the “full-screen” refers to the concept of not displaying any of the virtual representations of the vendable items themselves.

The substance of this full-screen advertisement 701 can again comprise promotional and/or non-promotional content as desired. When offering promotional content via this approach, the promotional content can relate directly to the offerings of the vending machine itself 200 or can relate, for example, to related offerings. To illustrate the latter opportunity, this promotional material can serve to make the viewer aware of a discount opportunity for a particular product at a given retail venue. When locating this machine near or inside such a retail venue, for example, such an advertisement can serve to inform a consumer of a potentially highly-relevant purchasing opportunity.

When using this full-screen advertisement mode 403, as noted, the viewer no longer sees the available selectable vendable items. As this may potentially give rise to some uncertainty regarding how to engage the machine 200 in order to effect a vending transaction, a “touch here” (or the like) soft button 702 can also be provided on the display 202. Upon touching (when using a touch screen), clicking upon, or otherwise selecting this soft button 702, the process can revert to the active vending mode 103 as described herein.

Referring again to FIG. 4, this full-screen advertisement mode 403 can continue until the stand-by mode 101 makes a determination at step 404 to exit. As with the banner-mode exit decision step 402 described earlier, this exit determination step 404 can be based upon whatever exit criteria may be relevant and useful to a given application setting.

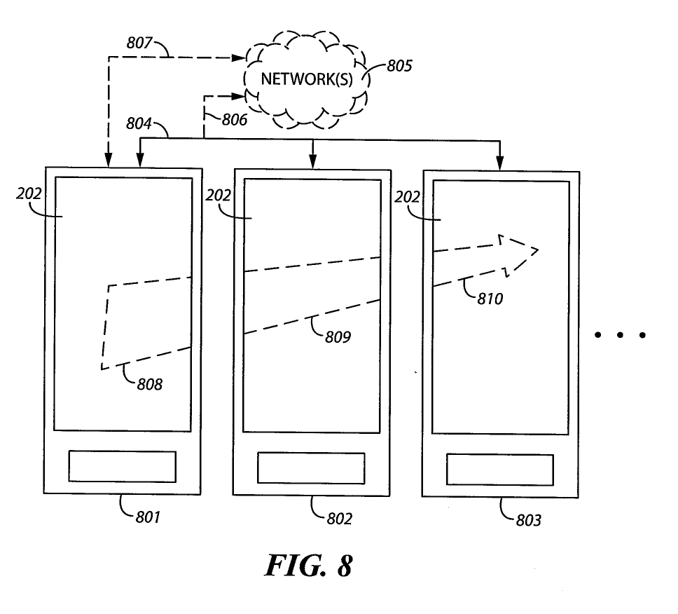

As noted earlier, such a display-based vending machine 200 may interact with other like machines via a corresponding data interface 210. In such a case, and as desired, this stand-by mode 101 will also optionally accommodate a multi-machine mode 405. Referring momentarily to FIG. 8, and by way of illustration and with no intention of suggesting any limitations in these regards, three or more such machines 801, 802, and 803 are coupled one to another via a wireless or a non-wireless serial bus 804. (It is also possible for this bus 804 to couple to one or more other networks 805 (such as the Internet) via a corresponding wireless or non-wireless link 806, or for only a single one of these machines 801 to couple to such a network 805 via its own separate link 807. So configured, these machines 801, 802, and 803 can have access to additional renderable content, pricing information, inventory and replenishment protocols, security resources, and so forth.)

Given such a configuration, the various displays 202 of these machines 801, 802, and 803 can be employed as components of a larger composite display. Using this approach, for example, a first part 808 of a given composite display can appear on a first one of the machines 801, a second part 809 of that composite display can appear on a second one of the machines 802 that is adjacent the first, and a third part 810 of that composite display can appear on a third machine 803 that is adjacent the second. This composite display can comprise a still image or a moving video image as desired. Such a composite display can serve to attract attention and/or to promote, directly or indirectly, an intuitive understanding that these machines are interrelated and may have other interrelated features (with some further examples in such regards being presented below).

Referring again to FIG. 4, a decision step 406 can determine when to exit this multi-machine mode 405 using whatever decision-making criterion may be of interest.

Various exit decisions have been described when offering this explanation of the stand-by mode 101. Generally speaking, these exit decisions are decisions being made in the absence of an interested customer engaging the machine 200. With reference again to FIG. 1, those skilled in the art will understand that the intervention of a customer at step 102 may favorably serve as a real time or near-real time interrupt with respect to the execution of the stand-by mode 101.

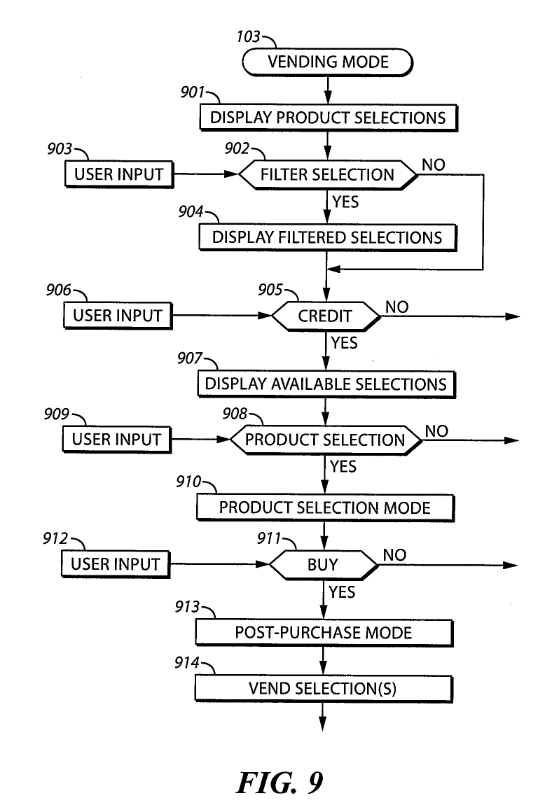

Referring now to FIG. 9, the aforementioned vending mode 103 will be described. As noted earlier, this mode presumes that the display-based vending machine 200 is now interfacing with a customer. Accordingly, this vending mode 103 includes the step 901 of displaying available product selections. This can comprise, as described above in conjunction with FIG. 5, presenting a virtual display of all available product selections 503 in a row-based and/or column-based presentation. This can comprise, for example, a pictorial representation of each item as it will otherwise physically appear upon being vended (adjusted, perhaps, for size or shape or by the deletion, addition, or modification of specific textual items, seasonal or promotions-specific content, graphic elements, or the like). Using this approach, for example, a vendable bag of chips will appear on the display 202 as a bag of chips while a vendable box of cookies will appear on the display 202 as a box of cookies.

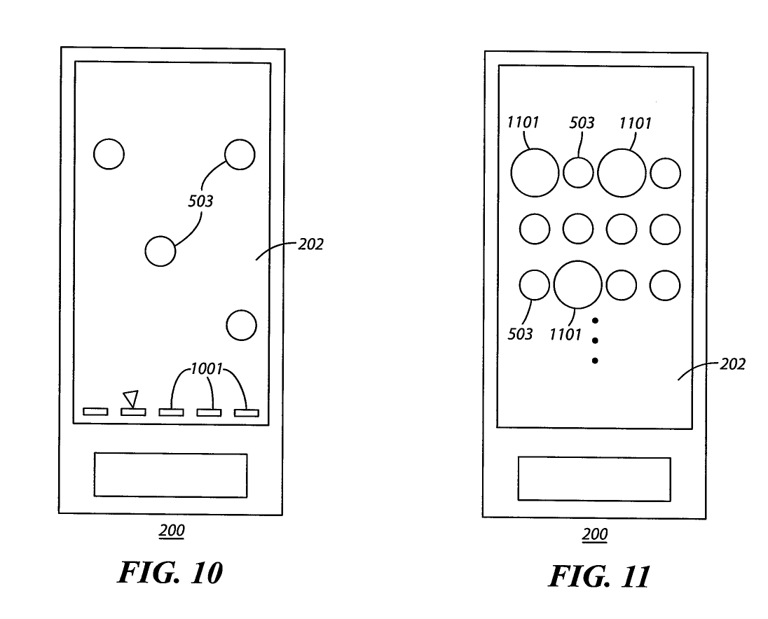

Referring momentarily to both FIGS. 9 and 10, these teachings will accommodate presenting one or more user-selectable filter criteria 1001 on the display 202. These can comprise, for example, criteria by which a customer can choose to winnow down the presentation of selections of present interest. When offering snacks and other food items, for example, illustrative examples in this regard might comprise “low fat,” “salty,” “chocolate,” “no nuts,” “cheesy,” or the like. When offering this option, this vending mode 103 can accommodate the step 902 of detecting corresponding user input 903 in these regards. Upon detecting such an input, this process can then provide the step 904 of displaying the filtered selections.

As shown in FIG. 10, by one approach this can comprise removing items from the display 202 that do not accord with the user's filter selection. This will leave only items 503 that accord with the user's filter selection, thus making it easier for the customer to make their final selection from amongst a smaller population of suitable candidates. Those skilled in the art will appreciate that this response can readily accommodate other approaches as well. As one illustrative example, this step 904 can comprise increasing the size of each item that meets the filter criterion while decreasing the size of each item that does not meet the filter criterion. As another illustrative example, the step 904 will accommodate the use of color, contrast, chroma, brightness, grayscale, or other related adjustments to effect a corresponding visual differentiation between items that meet the filter criterion and those that do not.

It is possible that a customer will insert their money, swipe their credit/debit card, or take another action that results in establishing a credit with the vending machine 200 prior to having indicated any particular item selection. In such a case, and if desired, this vending mode 103 will optionally provide the step 905 of detecting user input 906 that establishes such a credit and prompt the step 907 of displaying selections that are available at that level of credit.

Referring now to both FIGS. 9 and 11, as one illustrative example in these regards, this step 907 can comprise increasing the relative size of items 1101 that are available at the present level of credit with respect to other items 503 that would require a higher level of credit. For example, if the customer had deposited fifty cents into the vending machine 200, then this step 907 could comprise distinguishing the presentation of all items that cost fifty cents or less to permit the customer to easily identify those items that are available at or below that price point. If and as the customer increases the credit level, this process can dynamically respond by adjusting this display of available items in a corresponding manner.

At step 908, this mode detects user input 909 indicating that the customer has selected a particular item. This might comprise, for example, detecting that the customer has touched the display 202 at a location that presents the particular item. When this occurs, this mode can respond with a product selection mode 910.

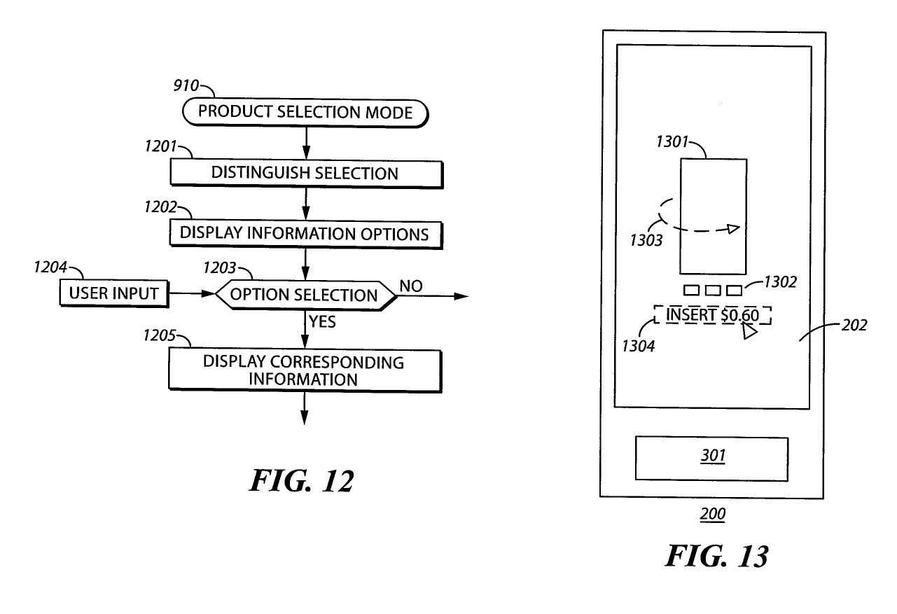

Referring now to both FIGS. 12 and 13, this product selection mode 901 can include the step 1201 of visually distinguishing in some way the selected item 1301 on the display 202. By one approach, and as suggested by the illustration, this can comprise removing some or all of the unselected items from the display 202 (or otherwise reducing their visibility via size reduction, color reduction, contrast reduction, or the like). This can also comprise moving the selected item's virtual representation to a more central location on the display 202 (unless the item is already coincidentally so located) and increasing its size. Such actions make it easier for the customer to perceive and identify their particular selection.

This product selection mode 910 will also optionally support the step 1202 of displaying information options (using, for example, corresponding user-selectable soft buttons 1302 on the display). To illustrate, one such option might comprise a “rotate” option, one might comprise an “ingredients” option, and yet another might comprise a “nutritional information” option. By selecting the “rotate” option button, for example, the customer can cause the displayed virtual item to rotate as indicated by the phantom arrow denoted by reference numeral 1303. By one approach, selecting this button once will cause the item to make a complete 360 degree rotation about its vertical access. By another approach, each selection of this button will cause the item to rotate some predetermined distance such as ninety degrees. By yet another approach, rotation will occur so long as the customer presses the corresponding button.

A rotation option will permit the customer to virtually handle the product and/or its packaging and permit visual inspection of its various sides. The aforementioned “ingredients” option can cause, for example, a corresponding display of textual and/or illustrative information detailing the ingredients that comprise the selected item 1301. Similarly, the “nutritional information” option can cause a corresponding display of textual and/or illustrative information detailing nutritional information for the selected item 1301.

These teachings will readily accommodate numerous variations in these regards. For example, an “open” option could be used to open the virtual packaging for the selected item 1301 and to permit the customer to view the virtual contents of this package. A “dispense” option could be used to present a display of the item being, for example, poured out into a serving dish or the like.

So configured, this product selection mode can provide the step 1203 of detecting such user input 1204 and providing the responsive step 1205 of displaying the corresponding information as described above.

If the customer has not yet established sufficient credit to purchase the selected item 1301, these teachings will accommodate presenting the customer with information 1304 representing the amount required to complete the transaction. This can comprise a dynamic value that changes, for example, as the customer inserts coins to reach the required amount. Once the customer as established a sufficient credit, this display can then present the customer with a “purchase now” (or the like) button.

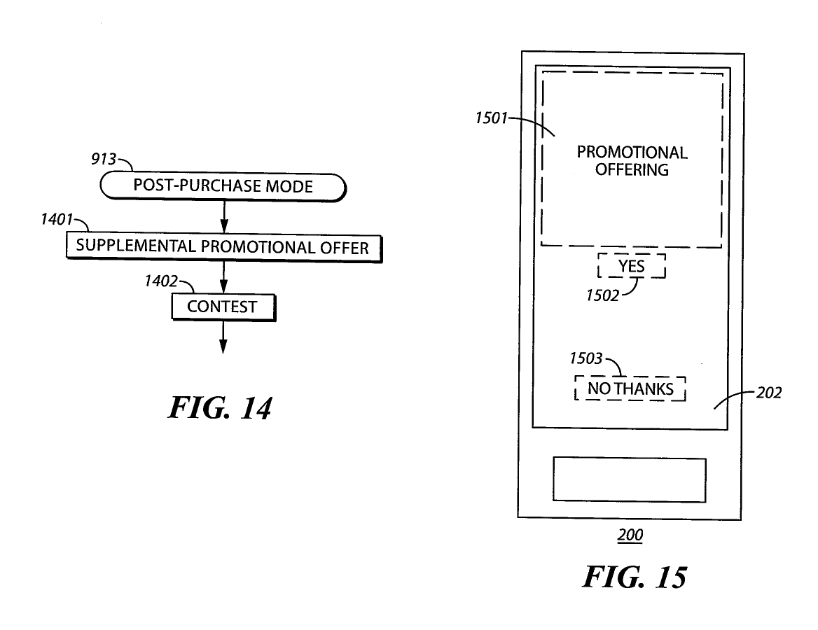

Referring again to FIG. 9, the vending mode 103 includes step 911 to detect user input 912 indicating such a purchase decision. The vending mode 103 responds by effecting a post-purchase mode 913. Referring now to FIG. 14, this post-purchase mode 913 can optionally comprise steps such as the step 1401 of providing a supplemental promotional offer. Referring momentarily to FIG. 15, by way of illustration this can comprise providing a supplemental promotional offering 1501 on the display 202.

For example, when the customer had deposited a one dollar bill and then selected a fifty cents item, this promotional offering 1501 could comprise an offer to use the remaining fifty cents in credit to purchase an additional item at discount. This might comprise, say, offering a seventy-five cents item in exchange for the remaining fifty cents.

As another example in these regards, this promotional offering 1501 can comprise an offer to provide the customer with a discount or rebate coupon. This coupon, if accepted, could be printed out by and at the machine 200 or could be emailed to an email address or faxed to a fax number as provided by the customer (using, for example, a displayed touch screen keyboard). As another option, this coupon could comprise a Bluetooth coupon that the machine 200 provides, upon acceptance, to the customer's cellular telephone, personal digital assistant, or the like.

To facilitate these offerings, the display 202 can present an acceptance button 1502 and a decline button 1503. The customer can then use these intuitive alternatives to indicate their desired result.

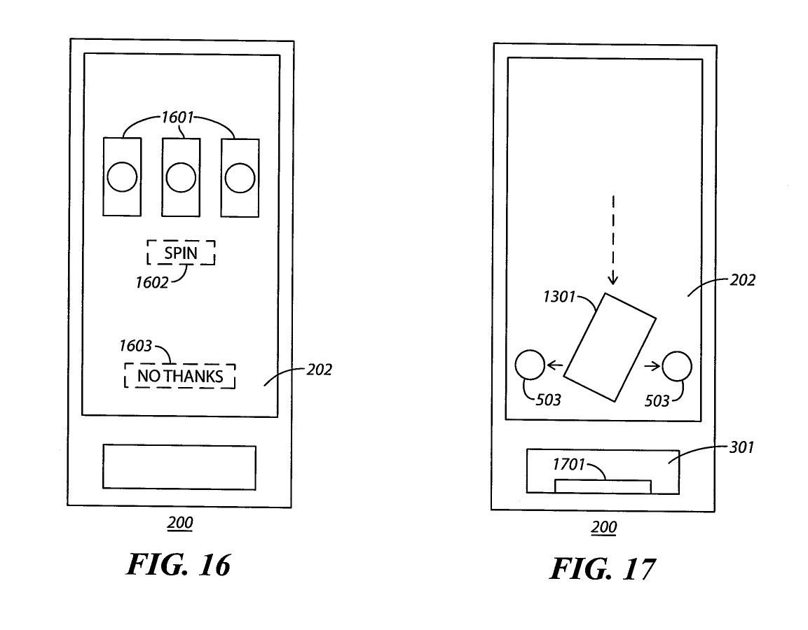

Referring again to FIG. 14, this post-purchase mode 913 can also optionally comprise, alone or in combination with the foregoing, a contest 1402 such as an instant win game. As an illustrative example in these regards, and referring now to FIG. 16, an instant win game based upon the display of a slot machine can feature a number of windows that each feature spinning shapes. By one approach, these shapes can relate to the item that the customer has selected. For example, when the customer has selected a bag of peanuts, these shapes can comprise differently-shaped peanuts.

The customer in this example can select between a “spin” button 1602 and a button 1603 to decline participating in the instant-win promotion. Declining will prompt the process to exit this activity. The “spin” button 1602, however, will cause the shapes in the windows 1601 to appear to spin. Like a slot machine, the revolving shapes in the windows 1601 will slow down and eventually stop. The combination of the particular shapes appearing in the window when this occurs then indicates whether the customer has won or lost.

By one approach, the winning customer can be immediately rewarded. This can comprise, for example, permitting the customer to select one or more additional items from the machine 200 without cost. By another approach, and as may be appropriate when rewarding the customer with a prize that cannot be suitably administered via the machine, the winning customer can be provided with a telephone number (such as a toll free telephone number) to call or text along with a winning code value to present to validate their winning status.

Referring now to both FIGS. 9 and 17, the vending mode 103 in this illustrative example concludes with the step 914 of vending the customer's selection or selections. By one approach, this vending activity can simply comprise physically moving the selected item 1701 to the area 301 where the customer can receive the item 1701 and remove it from the machine 200. This activity can also comprise returning change, if any, to the customer, providing a printed (or wirelessly transmitted) receipt to the customer, providing a “thank you” message to the customer, and so forth.

As illustrated in FIG. 17, this vending activity can also comprise further use of the display 202 if desired. By one approach, for example, the physical vending of the selected item 1701 can be accompanied by the virtual dropping of the depiction 1301 of the selected item from its previous position down towards the receiving area 301. Other related animations, if desired, can be employed as well. As one simple example in this regard, other non-selected items 503 as may be present on the display 202 can appear to move aside to make room for the dropping selected item 1301.

Those skilled in the art will appreciate the great flexibility, scalability, and leveragability offered through implementation of these teachings. Consider, for example, the synergies that are available by networking two or more such machines 200. A customer at one such machine can be presented with an opportunity to select a combination purchase (such as a so-called value meal) from amongst this plurality of machines. The display 202 for this first machine can present this customer with the aggregated purchasing opportunities for all of these machines. The customer, in turn, can make selections from this aggregation, and can pay for these selections while at this one machine. The customer can then visit the other machines to retrieve their purchases.

As another related example, discounts can be offered to a customer who makes a multi-machine purchase as described above. Also as another related example, the displays of these various machines can be utilized in favor of this one customer to, for example, guide the customer to the appropriate machine(s) following the purchase event to retrieve their items.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A vending apparatus comprising:
a housing containing products available to be vended via the vending apparatus;
a vended-product delivery area accessible via a front surface of the housing;
a video display configured to present dynamic content via the front surface of the housing, the video display having a display area that is by size at least forty percent of the front surface of the housing.

2. The vending apparatus of claim 1 wherein the dynamic content includes a depiction of at least some of the products.

3. The vending apparatus of claim 2 wherein the depiction comprises a view of vendable items as stored in an item storage area.

4. The vending apparatus of claim 2 wherein the dynamic content further includes at least on occasion banner content in combination with the depiction of at least some of the products.

5. The vending apparatus of claim 4 wherein the banner content pertains to at least one vendable item that is presently available via the vending apparatus.

6. The vending apparatus of claim 4 wherein the banner content does not pertain to an item that is vended by the vending apparatus.

7. The vending apparatus of claim 4 wherein the dynamic content includes substantially full-screen content.

8. A vending apparatus comprising:
a housing containing products available to be vended via the vending apparatus;
a video display configured to present dynamic content via a front surface of the housing;
a data interface configured to facilitate communications with at least one additional vending apparatus;
a control circuit disposed within the housing and being operably coupled to the video display and the data interface, the control circuit being configured to cause content displayed on the video display to comprise only a portion of a larger composite display that is formed using the display the at least one additional vending apparatus.

9. The vending apparatus of claim 8 wherein the larger composite display comprises a display of a still image.

10. The vending apparatus of claim 8 wherein the larger composite display comprises a display of a moving image.

11. The vending apparatus of claim 8 wherein the control circuit is further configured to offer to a customer at the vending apparatus at least one product that, in response to being selected for purchase by the customer via the vending apparatus, will be vended by the at least one additional vending apparatus.

12. The vending apparatus of claim 11 wherein the control circuit is further configured to display an offer of a purchase discount for a combination of products from the vending apparatus and the at least one additional vending apparatus.

13. A vending apparatus comprising:
a housing containing products available to be vended via the vending apparatus;
a video display configured to present dynamic content via a front surface of the housing, the video display;
a user-input interface;
a control circuit disposed within the housing and being operably coupled to the video display and the user-input interface, the control circuit being configured to permit a user to control at least part of the dynamic content prior to making a vending selection.

14. The vending apparatus of claim 13 wherein the control circuit is configured to permit the user to control at least part of the dynamic content by facilitating the user manipulating a display of a particular vendable item.

15. The vending apparatus of claim 14 wherein the control circuit is configured to facilitate the user manipulating a presentation of a particular vendable item by permitting the user to selectively rotate the presentation of the particular vendable item.

16. The vending apparatus of claim 13 wherein the control circuit is configured to permit the user to control at least part of the dynamic content by facilitating the user virtually opening the particular vendable item.

17. The vending apparatus of claim 16 wherein the control circuit is configured to provide a view of contents of the particular vendable item upon virtually opening the particular vendable item.

18. The vending apparatus of claim 13 wherein the control circuit is configured to permit the user to control at least part of the dynamic content by receiving at least one filter criterion selection from the user and then visually distinguishing a display of at least one vendable item in response to the at least one filter criterion selection.

19. The vending apparatus of claim 18 wherein visually distinguishing the display of at least one vendable item comprises continuing to display vendable items that correspond to the at least one filter criterion selection while not displaying vendable items that do not correspond to the at least one filter criterion selection.

20. The vending apparatus of claim 18 wherein visually distinguishing the display of at least one vendable item comprises displaying vendable items that correspond to the at least one filter criterion larger than vendable items that do not correspond to the at least one filter criterion.
